(19) United States
(12) Patent Application Publication
(10) Pub. No.: US 2012/0147511 A1
(43) Pub. Date: Jun. 14, 2012

(54) SMART GROUND BONDING METHOD FOR FACILITIES

(76) Inventor: Seon-Ho KIM, Daejeon (KR)

(21) Appl. No.: 13/323,969

(22) Filed: Dec. 13, 2011

(30) Foreign Application Priority Data
Dec. 13, 2010 (KR) 10-2010-0126683
Dec. 13, 2010 (KR) 10-2010-0126684
Dec. 13, 2010 (KR) 10-2010-0126685
Dec. 13, 2010 (KR) 10-2010-0126686

(51) Int. Cl. H02H 3/00

(52) U.S. Cl. 361/111

(57) ABSTRACT

Disclosed is a smart ground bonding method for facilities, wherein an electric wire is connected between a first facility and a second facility, a first surge protection device is connected between the first facility and the electric wire, a second surge protection device is connected between the electric wire and the second facility, and wherein ground terminals of the first and second surge protection devices are bonded to metal boxes of the first and second facilities and sides of the bonded metal boxes are connected to the ground. The present invention can form potential differences between all lines of facilities such that they correspond to an equipotential to a ground, blocking a surge current passing through the facilities and basically preventing damage due to a lightning surge.

### CROSS REFERENCES

Applicant claims foreign priority under Paris Convention to Korean Patent Application Nos. 10-2010-0126683 filed 13 Dec. 2010, 10-2010-0126684 filed 13 Dec. 2010, 10-2010-0126685 filed 13 Dec. 2010, and 10-2010-0126686 filed 13 Dec. 2010, with the Korean Intellectual Property Office, where the entire contents are incorporated herein by reference.

### BACKGROUND OF THE INVENTION

1. Field of the Invention

The present invention relates to a smart ground bonding method for facilities. More particularly, the present invention relates to a technology for forming potential differences between all lines of facilities such that they correspond to an equipotential to a ground, blocking a surge current passing through the facilities and basically preventing damage due to a lightning surge.

2. Description of the Prior Art

Various plant facilities are installed on a mesh ground, in which case it is theoretically preferable to install all facilities on one mesh ground. This is because a potential difference is not generated between the facilities even when power lines and communication lines are connected between the facilities while not being influenced by a lightning surge greatly.

However, it is general to install various facilities on mesh grounds respectively in reality. In this case, since a ground resistance is basically much higher than resistances of lines such as power lines and communication lines when the lines are connected between the facilities, if a potential difference is generated between grounds, a high ground potential fails to produce an equipotential but flows reversely due to a low line resistance and the reverse current incurs damage while a lightning current flows to a remote ground through a line via a device.

Thus, as illustrated in FIG. 1, in order to prevent damage due to a lightning surge, a surge protection device 4 is installed on a wire connected between facilities 1 and 2, in which case a core 3a of the wire 3 is connected to terminals of the facilities 1 and 2 and opposite ends of a shield line 3b are connected to a ground by using the shield line 3b as a ground wire.

However, in an aspect of a surge impedance of the wire, assuming that a surge frequency is 1 MHz, L=1.64 μH/m at a surge impedance (xL=2πfL) having a ground wire of 1 m, a surge impedance is 10.08 Ω/m. Meanwhile, if a length of the ground wire is 1 Km, since a surge impedance is approximately 10 KΩ which is very high, an effect of the ground wire becomes weak. Accordingly, if a potential difference is generated between points of a facility A and a facility B, a device breaks down in a process of flowing a surge current from an earth ground having a high potential to an earth ground having a low potential.

A surge protection device is installed between a wire and a control circuit in a control board installed to supply electric power to electric and electronic devices connected to a facility of a factory or a plant, control an operation of equipment, and transfer information, in order to prevent a damage to a device due to a surge, and ground terminals of the surge protection device and the control circuit are bonded to a ground terminal block through a wire to form an equipotential between the wires and the devices through an equipotential bonding method.

However, according to the equipotential bonding method for a control board, ground terminal boxes 180 of the control circuit 120 and the surge protection devices 130 to 160 are connected to each other by using a ground wire 170, in which case reactance components for surge frequencies (20 KHz to 20 MHz) of the ground wires increase and skin effects due to small cross-sections of the ground wires are applied greatly, significantly lowering an equipotential bonding effect between the surge protection devices due to a voltage drop (i.e. generation of a potential difference) for a surge.

Moreover, a metal structure such as an underground well or a metal pipe is installed in the vicinity of equipment including a control board, in which case even when an equipotential bonding is achieved in the control board, a potential difference is generated depending on a distance between an earth ground of the control board and a peripheral metal structure. This is a natural phenomenon generated by clouds, and when a potential difference is generated between a ground body of a well and an earth ground, a control circuit 220 breaks down due to a surge current.

### SUMMARY OF THE INVENTION

Accordingly, the present invention has been made to solve the above-mentioned problems occurring in the prior art, and an object of the present invention is to provide a technology of substantially realizing an equipotential between two facilities when a surge current is generated through a wire connecting the facilities spaced apart from each other, preventing one of the facilities from being damaged by a lightning surge generated in the other facility.

The present invention also provides a technology of connecting a power supply surge protection device and a communication surge protection device to a common ground terminal to form potential differences between all wires of facilities such that they correspond to an equipotential to the ground, blocking a surge current passing through the facilities basically preventing damage due to a lightning surge.

The present invention also provides a technology of connecting a metal structure in a facility to a common ground terminal or utilizing it as a common ground terminal, forming an equipotential with reference to an introduction part of the facility and blocking a surge current passing through a plant facility.

In order to accomplish this object, there is provided a smart ground bonding method for facilities, wherein an electric wire is connected between a first facility and a second facility, a first surge protection device is connected between the first facility and the electric wire, a second surge protection device is connected between the electric wire and the second facility, and wherein ground terminals of the first and second surge protection devices are bonded to metal boxes of the first and second facilities and sides of the bonded metal boxes are connected to the ground.

Preferably, only one of opposite ends of a shield line of the electric wire is grounded.

In accordance with another aspect of the present invention, there is provided a smart ground bonding method for a facility, wherein a ground terminal of at least one surge protection device installed in a facility of a metal box is bonded to an adjacent metal box and one side of the bonded metal box is connected to the ground.

Preferably, the facility is a control board, the metal box is a metal panel where a control circuit is installed, and a ground terminal of the control circuit is bonded to the metal panel.

In accordance with another aspect of the present invention, there is provided a smart ground bonding method for a facility to which a power supply line and a communication line are connected, wherein a power supply surge protection device is connected to the power supply line, a communication surge protection device is connected to the communication line, ground terminals of the power supply surge protection device and the communication surge protection device are connected to each other to form a common ground terminal, and the common ground terminal is connected to a conductive frame of the facility.

Preferably, the conductive frame is a box for the facility, the ground terminals of the power supply surge protection device, the communication surge protection device and a ground terminal of the facility are bonded to the conductive frame of the facility, and a ground terminal is formed at one side of the conductive frame to be connected to an external ground.

Preferably, the external ground is a metal structure located in the vicinity of the facility.

Preferably, the metal structure includes at least one of a water pipe, a water main, a gas pipe, a hot water pipe, a water supply pipe, a water discharge pipe, a wire pipe, a frame, a frame of a machine, a frame of a building, a box of a facility, a grouting of an underground well, a casing, a lift head pipe, and a water supply pipe for a fire prevention system.

In accordance with another aspect of the present invention, there is provided a smart ground bonding method for grounding a metal structure where an electric device is installed and a control facility installed adjacent to the metal structure, wherein a ground terminal box of the control facility and the metal structure are bonded and connected to each other by using a wire.

Preferably, the metal structure is an underground well and the ground terminal box of the control facility and a metal grouting pipe of an underground well are bonded to each other.

Preferably, the metal structure is a metal pipe and the ground terminal block of the control facility and the metal pipe as a ground body are bonded to each other.

Preferably, the ground terminal of the electric device is bonded and connected to the metal structure.

Preferably, the ground terminal block is installed at a location closest to the metal structure.

Preferably, a ground terminal of at least one surge protection device installed in the control facility is bonded to the metal panel where a control circuit is installed.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a conventional facility grounding structure;

FIG. 2 illustrates a facility grounding structure according to the first embodiment of the present invention;

FIG. 3 is a facility grounding structure according to the second embodiment of the present invention;

FIG. 4 illustrates a facility grounding structure according to the third embodiment of the present invention;

FIG. 5 illustrates a facility grounding structure according to the fourth embodiment of the present invention;

FIG. 6 illustrates a facility grounding structure according to the fifth embodiment of the present invention;

FIG. 7 illustrates a ground bonding structure in a control board including a metal box as an example of the present invention;

FIG. 8 illustrates a control board as an example of the present invention and a ground bonding structure between the control board and an underground well installed adjacent thereto; and

FIG. 9 illustrates a control board as an example of the present invention and a ground bonding structure between the control board and a metal pipe installed adjacent thereto.

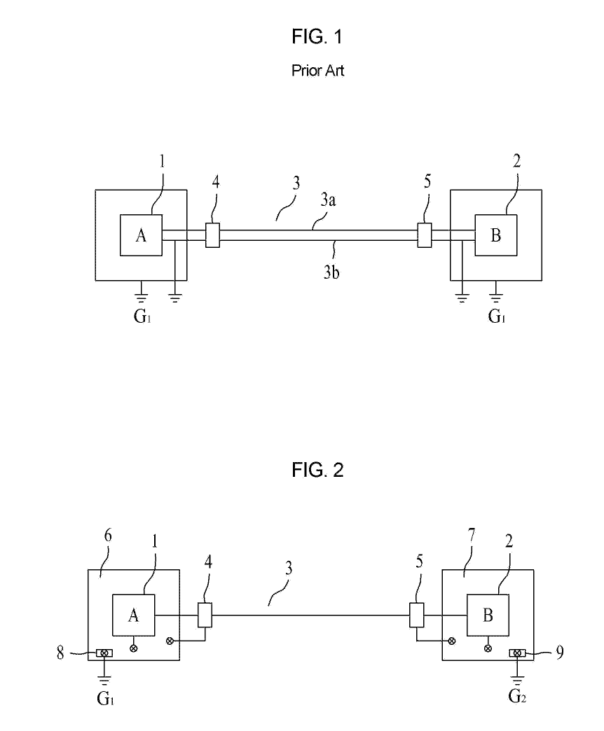

### DETAILED DESCRIPTION OF THE PREFERRED EMBODIMENTS

Hereinafter, an exemplary embodiment of the present invention will be described in detail with reference to the accompanying drawings.

FIG. 2 illustrates a facility grounding structure according to the first embodiment of the present invention.

As illustrated in FIG. 2, in the facility grounding structure according to the first embodiment of the present invention, an electric wire is connected between a first facility 1 and a second facility 2, a first surge protection device 4 is connected between the first facility 1 and the electric wire 3, a second surge protection device 5 is connected between the electric wire 3 and the second facility 2, and ground terminals of the first and second surge protection devices 4 and 5 are connected to the ground.

The ground terminals of the first and second surge protection devices 4 and 5 are bonded to metal boxes 6 and 7 of the first and second facilities, and ground terminal blocks 8 and 9 connected to the ground are formed on sides of the metal boxes 6 and 7. Here, the surge protection devices 4 and 5 are bonded to portions in the metal boxes 6 and 7 of the facilities 1 and 2 closest to the surge protection devices 4 and 5.

Conventionally, ground wires are used to connect facilities 1 and 2, ground terminals of the surge protection devices 4 and 5, and ground terminal blocks, in which case reactance components for surge frequencies (20 KHz to 20 MHz) of the ground wires increase and skin effects due to small cross-sections of the ground wires are applied greatly, significantly lowering an equipotential bonding effect between the surge protection devices due to a voltage drop (i.e. generation of a potential difference) for a surge.

For example, when a common supply voltage of 60 Hz is applied to a ground wire, the reactance of the ground wire is several hundred micrometers, which is very low and can be neglected, and when a surge current of 1 MHz flows through the ground wire, the reactance of the ground wire of 1 m is 10.08Ω (2πfL=6.28×10⁶×1.62×10⁻⁶), which is considerably high. Accordingly, a potential difference is generated between the surge protection devices due to the reactance component of the ground wire when a surge is generated, lowering an equipotential bonding effect.

To the contrary, according to the first embodiment of the present invention, since the ground terminals of the surge protection devices 4 and 5 are bonded to the metal box, the reactance between the facilities 1 and the surge protection devices 4 and 5 is remarkably reduced as compared with the conventional ground wire, making it possible to substantially form an equipotential when a surge is introduced. This is because since the bonding parts are not connected through a wire of a small cross-section but connected through a metal panel of a large area, a skin effect and accordingly the reactance are very low.

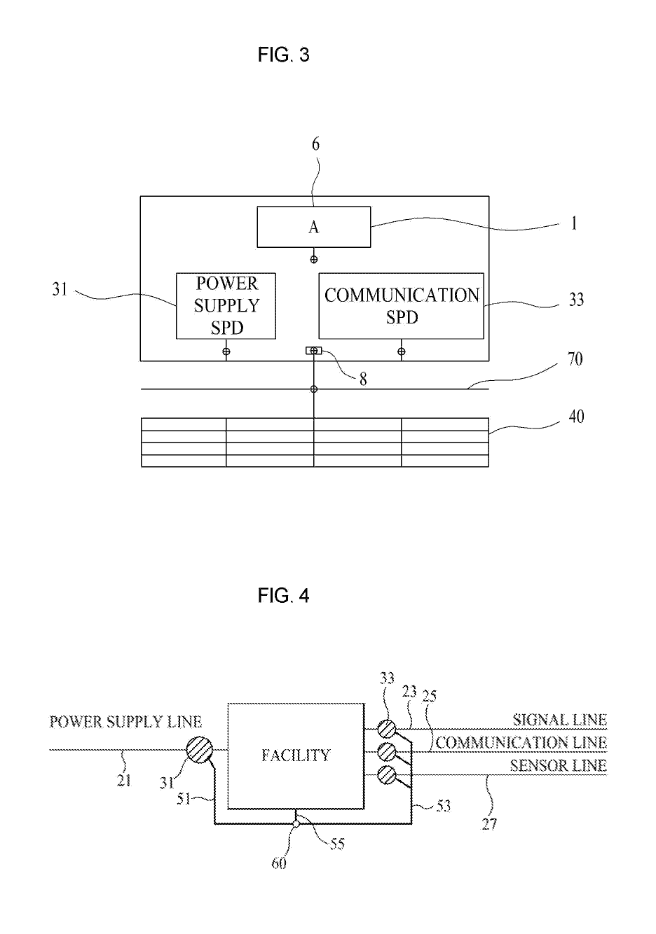

FIG. 3 is a facility grounding structure according to the second embodiment of the present invention.

The second embodiment of the present invention corresponds to a structure where ground terminals of a power supply surge protection device 31 and a communication surge protection device 33 installed in one facility are bonded to closest portions of a metal box 6 and a ground terminal block 8 formed on one side of the metal box 6 is connected to a mesh ground 40 or is connected to a nearby metal structure when there is no ground or a defective ground.

Here, it is preferable that the metal structure contacts the earth or is located to face the earth, which is because the metal structure such as a metal pipe or a steel frame of a building is installed in the vicinity of the ground surface, acting as an excellent ground by itself.

Here, the metal structure includes a water pipe, a water main, a gas pipe, a hot water pipe, a water supply pipe, a water discharge pipe, a wire pipe, a frame, a frame of a machine, a frame of a building, a box of a facility, a grouting of an underground well, a casing, a lift head pipe, and a water supply pipe for a fire prevention system.

FIG. 4 illustrates a facility grounding structure according to the third embodiment of the present invention.

As illustrated in FIG. 4, various lines such as a power supply line 21, a signal line 23, a communication line 25, and a sensor line 27 are connected to a facility of a plant, and a power supply surge protection device 31 is connected to the power supply line 21 and the facility, and a communication surge protection device 33 is connected to communication lines such as the signal line 23, the communication line 25, and the sensor line 27.

While the power supply surge protection device 31 and the communication surge protection device 33 are conventionally grounded to a mesh ground in a single grounding manner, the ground terminals of the power supply surge protection device 31 and the communication surge protection device 33 are connected to each other to form a common ground terminal 60 and the common ground terminal 60 is connected to a conductive frame (not shown) of the facility through the ground wire 55.

Accordingly, a potential difference between all the lines corresponds to an equipotential to the ground through the surge protection devices 31 and 33 and even an outer box (conductive frame) of a facility forms an equipotential, which prevents damage due to a lightning surge as a surge current passing through the plant facility disappears.

The embodiment of the present invention corresponds to a very effective structure when there is no ground or a defective ground, and is not relevant to the earth ground.

It is apparent that the common ground terminal 60 may be connected to the earth ground when there is an excellent earth ground.

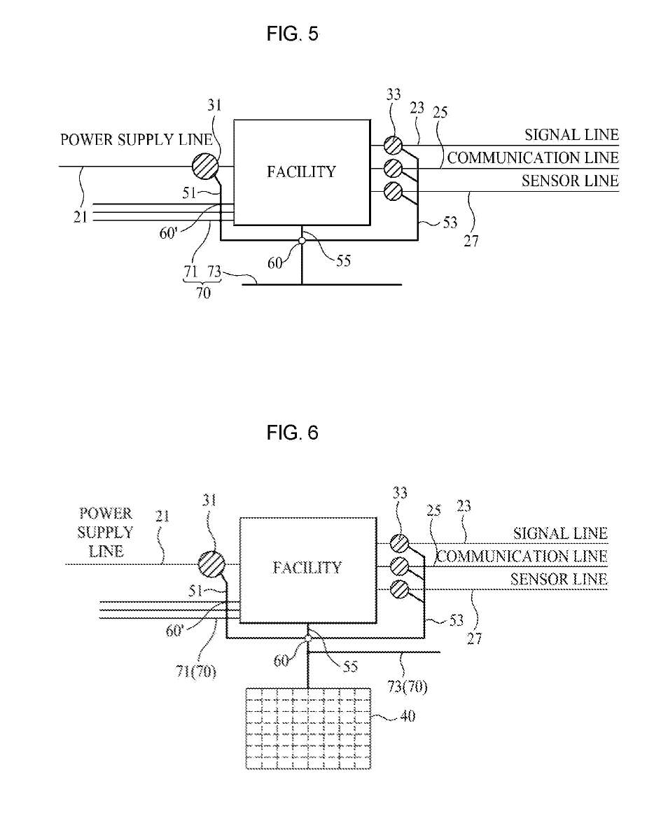

FIG. 5 illustrates a facility grounding structure according to the fourth embodiment of the present invention.

The fourth embodiment of the present invention also has a structure where various lines connected to a facility of a plant and a power supply surge protection device 31 and a communication surge protection device 33 are connected between a power supply line 21 and the facility and between the communication line and the facility.

The fourth embodiment of the present invention has a structure where a common ground terminal 60 is bonded to a metal structure 70 located in a facility, in addition to a structure where the power supply surge protection device 31 and the communication surge protection device 33 are connected to each other to form a common ground terminal 60 and the common ground terminal 60 is connected to a conductive frame (not shown) of a facility through a ground wire 55.

Here, the metal structure 70 includes a water pipe, a water main, a gas pipe, a hot water pipe, and a metal frame, and one of the ground wires 51 and 53 connected to the common ground terminal 60 is bonded to the metal structure 70. Since a metal pipe and a steel frame of a building are installed in the vicinity of the ground surface, they act as excellent grounds by themselves and are very effective when there is no ground or a defective ground.

In a modified embodiment of the present invention, the ground wires 51 and 53 may be bonded to the metal structure 70 to form a common ground terminal 60′ and the ground terminals of the power supply surge protection device 31 and the communication surge protection device 33 may be connected to the common ground terminal 60′.

Accordingly, a potential difference between all the lines corresponds to an equipotential to the ground through the surge protection devices 31 and 33 and various pipes and the metal structure are used as ground bodies, showing a more excellent grounding performance.

According to the fourth embodiment of the present invention, since an equipotential is formed with reference to an introduction part of the facility, a surge current passing through the plant facility disappears, which prevents damage due to a lightning surge.

FIG. 6 illustrates a facility grounding structure according to the fifth embodiment of the present invention.

The fifth embodiment of the present invention also has the same structure where various lines are connected to a facility of a plant and a power supply surge protection device 31 and a communication surge protection device 33 are connected between a power supply line 21 and the facility and between a communication line and the facility.

The basis structure of the fifth embodiment of the present invention is the same as that of the fourth embodiment of the present invention, but is different in that a common ground terminal 60 is connected to a mesh ground 40.

Accordingly, a potential difference between all the lines corresponds to an equipotential to the ground through surge protection devices 31 and 33, and various pipes and a metal structure are bonded to a ground body, i.e. a mesh ground 40 to be utilized as a ground element together with the ground body.

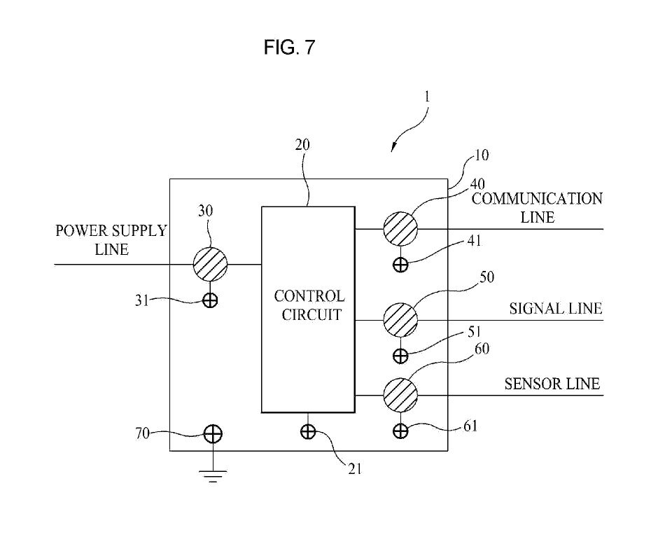

FIG. 7 illustrates a ground bonding structure in a control board including a metal box as an example of the present invention.

Referring to FIG. 7, the equipotential bonding structure in the control board according the present invention includes a control circuit 20 installed in the control board 1 having a metal box, a power supply surge protection device 30 installed between a power supply line and the control circuit 20, a communication surge protection device 40 installed between a communication line and the control circuit 20, bonding parts 21, 31, 41, 51, and 61 formed on a metal panel 10 by bonding ground terminals of a signal surge protection device 40 installed between a signal line and the control circuit 20 and a sensor surge protection device 60 installed between a sensor line and the control circuit 20, and a ground bonding part 70 for connecting a wire to one side of the metal panel 10.

Although it is illustrated in FIG. 7 that the ground terminals of the control circuit 20 and the surge protection devices 30 to 60 are bonded to one metal panel 10, it is apparent that bonding parts may be formed at the closest portion of the panels of the metal box of the control board 1 and the metal panel.

When the control circuit 20 and the ground terminals of the surge protection devices 30 to 60 are bonded to the metal panel of the metal box, the reactance between the control circuit 20 and the surge protection devices 30 to 60 and between the surge protection devices 30 to 60 themselves is remarkably reduced as compared with the conventional ground wires, substantially forming an equipotential even when a surge is introduced. This is because the bonding parts are not connected through a wire of a small cross-section but connected through a metal panel with a large area, and as such, a skin effect and accordingly the reactance are very low.

When there is an excellent earth ground, the ground wires extracted from the ground bonding parts 70 may be directly connected to the earth ground, but may be connected to a metal structure located in the vicinity when there is no ground or a defective ground in addition. Then, it is preferable that the metal structure contacts the earth or is located to face the earth, which is because the metal structure such as a metal pipe or a steel frame of a building is installed in the vicinity of the ground surface, acting as an excellent ground by itself.

Here, the metal structure includes a water pipe, a water main, a gas pipe, a hot water pipe, a water supply pipe, a water discharge pipe, a wire pipe, a frame, a frame of a machine, a frame of a building, a box of a facility, a grouting of an underground well, a casing, a lift head pipe, and a water supply pipe for a fire prevention system. Further, according to the present invention, the ground bonding part 70 may be formed in the control panel 10 and a ground wire may be connected between the ground bonding part 70 and the metal box of the control board 1.

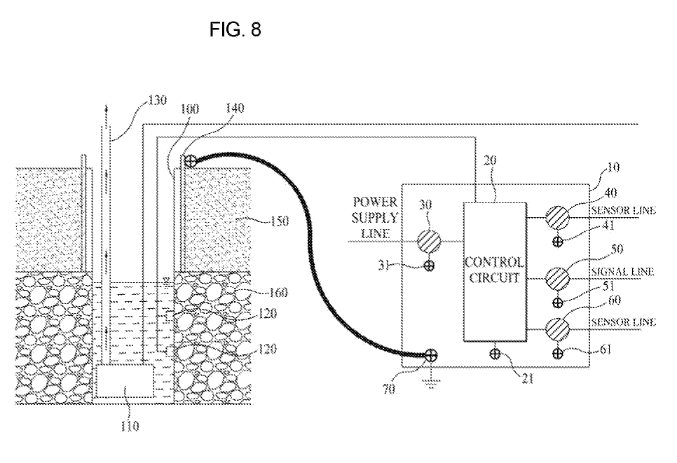

FIG. 8 illustrates a control board as an example of the present invention and a ground bonding structure between the control board and an underground well installed adjacent thereto.

In an underground well for pumping underground water, after a well 100 is formed by excavating the ground, a pumping pipe 130 where an electrical submersible pump is installed at a lower portion thereof is inserted into the well 100. A plurality of water level sensors 120 for measuring the water level of the underground water are installed at portions of the well corresponding to a bedrock layer.

The well 100 passes through an earth and sand layer at an upper portion of the ground surface and is formed in a bedrock layer 160 so that the underground water flowing through the bedrock gathers through a bedrock hole, and then the underground water collected in the well is compulsorily suctioned by the operation of the underwater motor pump 110 to be supplied to a water pipe along the pumping pipe 130.

It is general to insert a grouting pipe 140 of a metal in a size equal to a depth of an earth and sand layer 150 at a location of the earth and sand layer 150 of the well 100 in order to prevent the contaminated water existing in the peripheral earth and sand or the earth and sand layer 150 from being introduced into the well 100.

The wires of the underwater motor pump 110 and the water level sensor 120 contact the underground water, in which case since the underground water is an excellent ground and the underwater motor 110 and the water level sensor 120 are submerged in the water, it may act as an excellent ground body at a surge frequency (20 KHz to 20 MHz).

The equipotential bonding structure between the metal pipe and the control board using the metal grouting pipe 140 is as follows. Hereinafter, an equipotential bonding between an underground well and a control board and an equipotential bonding will be described.

### 1. Equipotential Bonding Between Underground Well and Control Board

First, an equipotential bonding between an underground well and a control board is performed by bonding a ground terminal block 70 of a control board 1 and a metal grouting pipe 140 of the underground well using wires.

The metal grouting pipe 140 acts as an excellent ground body inserted into and installed in the earth and sand layer 150 and contacting the earth and sand layer 150, and is located at the same point as the underwater motor pump 110 so that there is no potential difference between the grouting pipe 140 and the underwater motor pump 110.

Thus, since when the ground terminal block 70 of the control board 1 and the metal grouting pipe 140 of the underground well are bonded and connected to each other, the control board 1 is grounded to the metal grouting pipe 140 and a potential difference is not generated between the ground terminal block 70 of the control board 1 and the ground body of the underground well.

Here, it is preferable that the ground wire 80 connecting the ground terminal block 70 of the control board 1 and the metal grouting pipe 140 of the underground well employs a thick wire and a distance between the ground terminal block 70 and the metal grouting pipe 140, so that the reactance of the ground wire 80 and accordingly the potential difference are minimized.

2. Equipotential bonding in Control Board

In the equipotential bonding structure in the control board, the control circuit 20 installed in the control board 1 including the metal body and the ground terminals of the surge protection devices 30 to 60 are bonded to the metal panel 10 to form the bonding parts 21, 31, 41, 51, and 61 on the metal panel 10, and the ground terminal box 70 is installed at one side of the metal panel 10.

Although it is illustrated in FIG. 8 that the ground terminals of the control circuit 20 and the surge protection devices 30 to 60 are bonded to one metal panel 10, it is apparent that bonding parts may be formed at the closest portion of the panels of the metal box of the control board 1 and the metal panel.

When the control circuit 20 and the ground terminals of the surge protection devices 30 to 60 are bonded to the metal panel of the metal box, the reactance between the control circuit 20 and the surge protection devices 30 to 60 and between the surge protection devices 30 to 60 themselves is remarkably reduced as compared with the conventional ground wire, making it possible to substantially form an equipotential when a surge is introduced. This is because since the bonding parts are not connected through a wire of a small cross-section but connected through a metal panel with a large area, a skin effect and accordingly the reactance are very low.

As mentioned above, the ground wires 80 extracted from the ground bonding parts 70 may be bonded and connected to the metal grouting pipe 140 of the underground well installed in the vicinity and may be connected to the earth ground at the same time.

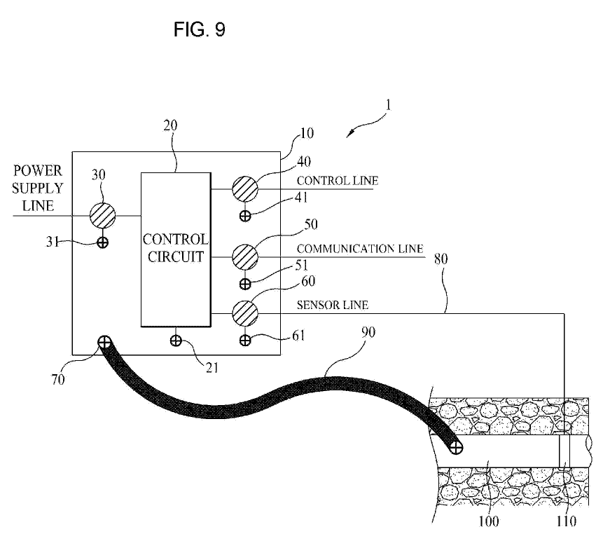

FIG. 9 illustrates a control board as an example of the present invention and a ground bonding structure between the control board and a metal pipe installed adjacent thereto.

A sensor and a control unit 110 for detecting a fluid passing through a metal pipe 100 buried underground, transmitting a detection signal to a control board 200, and blocking and controlling flow of the fluid in the metal pipe 100 according to a control signal of the control board 200 are installed at one side of an interior of the metal pipe 100. The sensor and the control unit 110 are connected to a control circuit 220 of the control board 200 through a sensor line 290 to transmit the detected sensing signal to the control board 200, in which case if a ground potential difference is generated depending on a distance between an earth ground of the control board 200 and the metal pipe 100, the control circuit 220 breaks down due to a surge current.

Hereinafter, the equipotential bonding structure between a metal pipe and a control board to solve the problem will be described.

1. Equipotential Bonding between Metal Pipe and Control Board

First, a equipotential bonding between a metal pipe and a control board is achieved by bonding and connecting the ground terminal block 70 of the control board 1 and the metal pipe 100 using a wire.

The metal pipe 100 may be buried underground and attached to the earth to be used as an excellent ground body. Accordingly, the ground terminals of electric devices installed on the metal pipe may be bonded to the metal pipe 100 so that the metal pipe 100 can be used as a ground body.

Accordingly, when the ground terminal box 70 of the control board 1 and the metal pipe 100 buried underground are bonded and connected to each other, since the control board 1 is grounded to the metal pipe 100, it is possible to prevent a potential difference from being generated between the ground terminal block 70 of the control board 1 and the metal pipe 100 as a ground body.

Here, it is preferable that a thick wire is used as the ground wire 90 connected the ground terminal block 70 of the control board 1 and the metal pipe 100 of the underground well and a distance between the ground terminal block 70 and the metal pipe 100 is minimized, making it possible to minimize a reactance of the ground wire 90 and a potential difference.

### 2. Equipotential Bonding in Control Board

In an equipotential bonding structure in a control board, ground terminals of a control circuit 20 installed in a control board 1 including a metal box and surge protection devices 30 to 60 are bonded to a metal panel 10 to form bonding parts 21, 31, 41, 51, and 61 on the metal panel 10 and a ground terminal block 70 is installed at one side of the metal panel 10.

Although it is illustrated in FIG. 9 that ground terminals of the control circuit 20 and the surge protection devices 30 to 60 are bonded to one metal panel 10, it is apparent that bonding parts may be formed at the closest portion of the panels of the metal box of the control board 1 and the metal panel.

When the ground terminals of the control circuit 20 and the surge protection devices 30 to 60 are bonded to the metal panel of the metal box, the reactance between the ground terminals of the control circuit 20 and the surge protection devices 30 to 60 is remarkably reduced as compared with the conventional ground wire, substantially achieving an equipotential even when a surge is introduced. Since the bonding parts are not connected through a wire of a small cross-section but connected through a metal panel of a large area, a skin effect and accordingly the reactance are very low.

As described above, the ground wires 80 extracted from the ground bonding parts 70 may be bonded and connected to the metal pipe 100 and may be connected to an earth ground at the same time.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A smart ground bonding method for facilities, wherein an electric wire is connected between a first facility and a second facility, a first surge protection device is connected between the first facility and the electric wire, a second surge protection device is connected between the electric wire and the second facility, and wherein ground terminals of the first and second surge protection devices are bonded to metal boxes of the first and second facilities and sides of the bonded metal boxes are connected to the ground.

2. The smart ground bonding method as claimed in claim 1, wherein only one of opposite ends of a shield line of the electric wire is grounded.

3. A smart ground bonding method for a facility, wherein a ground terminal of at least one surge protection device installed in a facility of a metal box is bonded to an adjacent metal box and one side of the bonded metal box is connected to the ground.

4. The smart ground bonding method as claimed in claim 1, wherein the facility is a control board, the metal box is a metal panel where a control circuit is installed, and a ground terminal of the control circuit is bonded to the metal panel.

5. A smart ground bonding method for a facility to which a power supply line and a communication line are connected, wherein a power supply surge protection device is connected to the power supply line, a communication surge protection device is connected to the communication line, ground terminals of the power supply surge protection device and the communication surge protection device are connected to each other to form a common ground terminal, and the common ground terminal is connected to a conductive frame of the facility.

6. The smart ground bonding method as claimed in claim 5, wherein the conductive frame is a box for the facility, the ground terminals of the power supply surge protection device, the communication surge protection device and a ground terminal of the facility are bonded to the conductive frame of the facility, and a ground terminal is formed at one side of the conductive frame to be connected to an external ground.

7. The smart ground bonding method as claimed in claim 6, wherein the external ground is a metal structure located in the vicinity of the facility.

8. The smart ground bonding method as claimed in claim 7, wherein the metal structure includes at least one of a water pipe, a water main, a gas pipe, a hot water pipe, a water supply pipe, a water discharge pipe, a wire pipe, a frame, a frame of a machine, a frame of a building, a box of a facility, a grouting of an underground well, a casing, a lift head pipe, and a water supply pipe for a fire prevention system.

9. A smart ground bonding method for grounding a metal structure where an electric device is installed and a control facility installed adjacent to the metal structure, wherein a ground terminal box of the control facility and the metal structure are bonded and connected to each other by using a wire.

10. The smart ground bonding method as claimed in claim 9, wherein the metal structure is an underground well and the ground terminal box of the control facility and a metal grouting pipe of an underground well are bonded to each other.

11. The smart ground bonding method as claimed in claim 9, wherein the metal structure is a metal pipe and the ground terminal block of the control facility and the metal pipe as a ground body are bonded to each other.

12. The smart ground bonding method as claimed in claim 9, wherein the ground terminal of the electric device is bonded and connected to the metal structure.

13. The smart ground bonding method as claimed in claim 9, wherein the ground terminal block is installed at a location closest to the metal structure.

14. The smart ground bonding method as claimed in claim 9, wherein a ground terminal of at least one surge protection device installed in the control facility is bonded to the metal panel where a control circuit is installed.
